(19) United States
(12) Patent Application Publication
(10) Pub. No.: US 2011/0254842 A1
(43) Pub. Date: Oct. 20, 2011

(54) ACOUSTIC IMAGING SYSTEM AND METHOD OF ACOUSTIC IMAGING WITH CONTRAST QUANITFICATION

(75) Inventors: Julia Dmitrieva, Bothell, WA (US); Jayne Louise Angela Armfield, Lynnwood, WA (US); Junzhen Man, Bothell, WA (US); Jeffry Earl Powers, Bainbridge Island, WA (US); Michael R. Voin, La Chaussee St Victor (FR)

(73) Assignee: KONINKLIJKE PHILIPS ELECTRONICS N.V., EINDHOVEN (NL)

(21) Appl. No.: 13/141,784

(22) PCT Filed: Dec. 7, 2009
(86) PCT No.: PCT/IB2009/055558

§ 371 Date: Jun. 23, 2011

Related U.S. Application Data
(60) Provisional application No. 61/140,154, filed on Dec. 23, 2008.

(51) Int. Cl. G06T 17/00; G06K 9/00

(52) U.S. Cl. 345/424; 382/131

(57) ABSTRACT

A system (100) and method (400) of acoustic imaging receives an acoustic signal that is scanned to interrogate a target volume within a subject (430), processes the received acoustic signal to produce three-dimensional acoustic image data for a region of interest within the target volume (450); and quantifies the contrast of the three-dimensional acoustic image data in the region of interest at a sampling time that is offset by a selected time period with respect to a time when a contrast enhancement medium is introduced into the subject's circulatory system (480). In one embodiment, quantification is performed by setting an intensity threshold (410), and determining a percentage of voxels of the three-dimensional acoustic image data for the region of interest which have an intensity value greater than the intensity threshold (470).

This invention pertains to acoustic imaging systems and methods, and more particularly to an acoustic imaging system and method which employs contrast enhancement.

Acoustic waves (including, specifically, ultrasound) are useful in many scientific or technical fields, such as in medical diagnosis and medical procedures, non-destructive control of mechanical parts and underwater imaging, etc. Acoustic waves allow diagnoses and visualizations which are complementary to optical observations, because acoustic waves can travel in media that are not transparent to electromagnetic waves.

For one example, acoustic imaging plays an important role in the detection and evaluation of tumors. Until recently, acoustic imaging has principally served the role of showing the neoplasm, helping to distinguish tumors from other pathologic processes.

Meanwhile, over the past few decades, the role of new blood vessels (angiogenesis) in the development of tumors has been recognized. In the light of the generally accepted importance of angiogenesis for tumor growth and progression, and the increasing number of antiangiogenic therapy protocols, the non-invasive monitoring of tumor perfusion during antiangiogenic therapy has gained in importance. Imaging studies play an important role in assessing the effects of these treatments. Experimental approaches in vivo or clinical trials often use reduction of tumor size or as a criterion for therapeutic efficacy. Furthermore, because many antiangiogenic agents are not cytotoxic, but instead produce disease stabilization, measurement of tumor size alone may be uninformative as an indication of therapeutic effect.

For this reason, physiologic, rather than solely anatomic, medical imaging techniques, may be beneficial in assessing tumor development and the effectiveness of a particular therapy in treating the tumor.

One development in the field of acoustic medical imaging is contrast enhancement. Contrast-enhanced ultrasound (CEUS) is the application of an acoustic (e.g., ultrasound) contrast medium to traditional medical sonography. Typically, ultrasound contrast agents in the form of gas-filled microbubbles are administered intravenously to a patient's bloodstream, and then acoustic images are generated on an area of interest. These microbubbles have a high degree of echogenicity, which is the ability of an object to reflect the acoustic waves. The echogenicity difference between the gas in the microbubbles and the soft tissue surroundings of the body provides a high degree of contrast between the acoustic backscatter, or reflection of the acoustic waves, by the microbubbles carried in the bloodstream, and the surrounding tissue.

Because contrast-enhanced acoustic imaging can be used to image blood perfusion in organs, it provides a promising tool for monitoring of tumor perfusion during antiangiogenic therapy.

However, existing methods and systems of contrast-enhanced acoustic imaging suffer from certain drawbacks.

Currently, there is no ultrasound method following the visual, vascular and measurement changes of a tumor in three dimensions (3D). Following therapy, tumors could enlarge/shrink, but the vascular supply of a tumor responding positively to therapy should diminish. However, tumors change their dimensions in a non-linear fashion, and often visualizing a tumor in two dimensions (2D) lacks diagnostic certainty because the dimensions of the tumor might have changed in a different plane than the one being visualized. Furthermore, the vascular supply is difficult to monitor in 2D since a radiologist will not always see the vessels if the scanning plane does not encompass the vessel length. Said another way, because a tumor may respond to treatment by shrinking, enlarging, or changing vascularity in three dimensions, two-dimensional acquisition might lack the necessary information, or might fail to display a particular plane, to demonstrate the changes.

Accordingly, it would be desirable to provide a system and method of acoustic imaging that can enhance the diagnostic capability of contrast-enhanced acoustic imaging.

In one aspect of the invention, a method of acoustic imaging comprises: (i) receiving an acoustic signal that is scanned to interrogate a target volume within a subject; (ii) processing the received acoustic signal to produce three-dimensional acoustic image data for a region of interest within the target volume; and (iii) quantifying a contrast of the three-dimensional acoustic image data in the region of interest at a sampling time that is offset by a selected time period with respect to a time when a contrast enhancement medium is introduced into the subject's circulatory system.

In another aspect of the invention, an acoustic imaging system comprises: a processor adapted to process an acoustic signal that is scanned to interrogate a target volume within a subject, and which acoustic signal is received by an acoustic transducer; a display device for displaying images in response to the processed acoustic signal; and a control device that is adapted to allow a user to control at least one operating parameter of the acoustic imaging apparatus. The processor is configured to execute an algorithm comprising: (i) processing the received acoustic signal to produce three-dimensional acoustic image data for a region of interest within the target volume; and (ii) quantifying a contrast of the three-dimensional acoustic image data in the region of interest at a sampling time that is offset by a selected time period with respect to a time when a contrast enhancement medium is introduced into the subject's circulatory system.

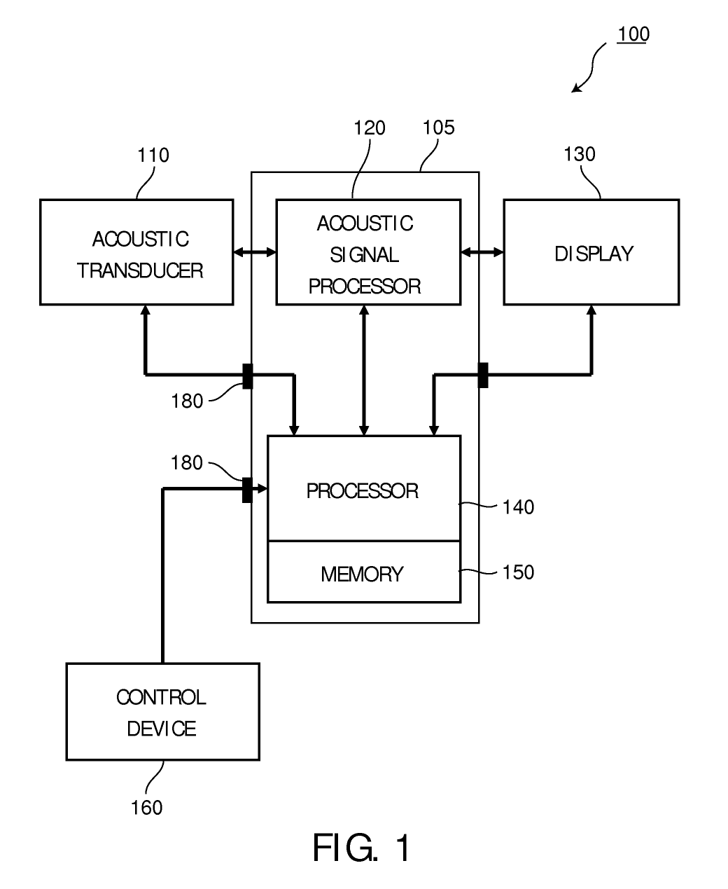

FIG. 1 is a block diagram of an acoustic imaging system.

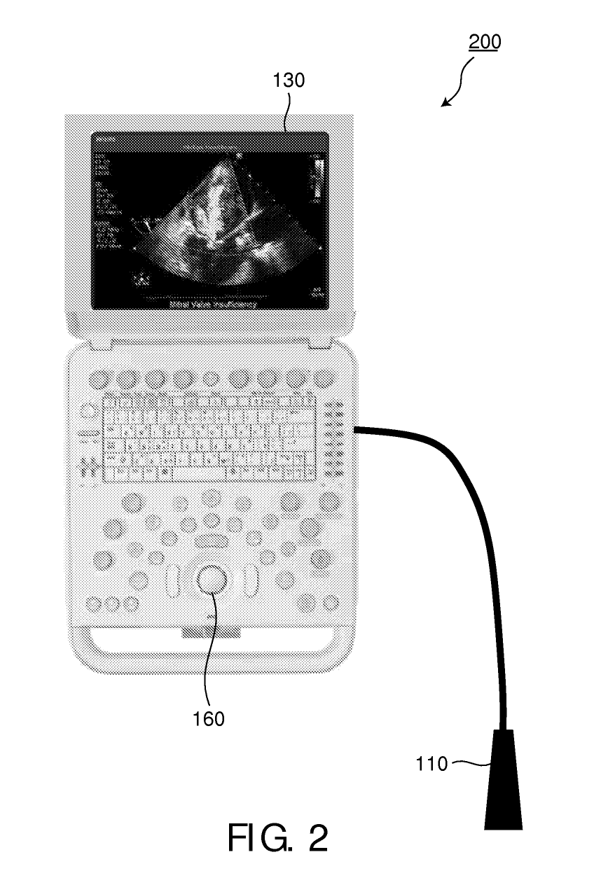

FIG. 2 illustrates one embodiment of the acoustic imaging system of FIG. 1.

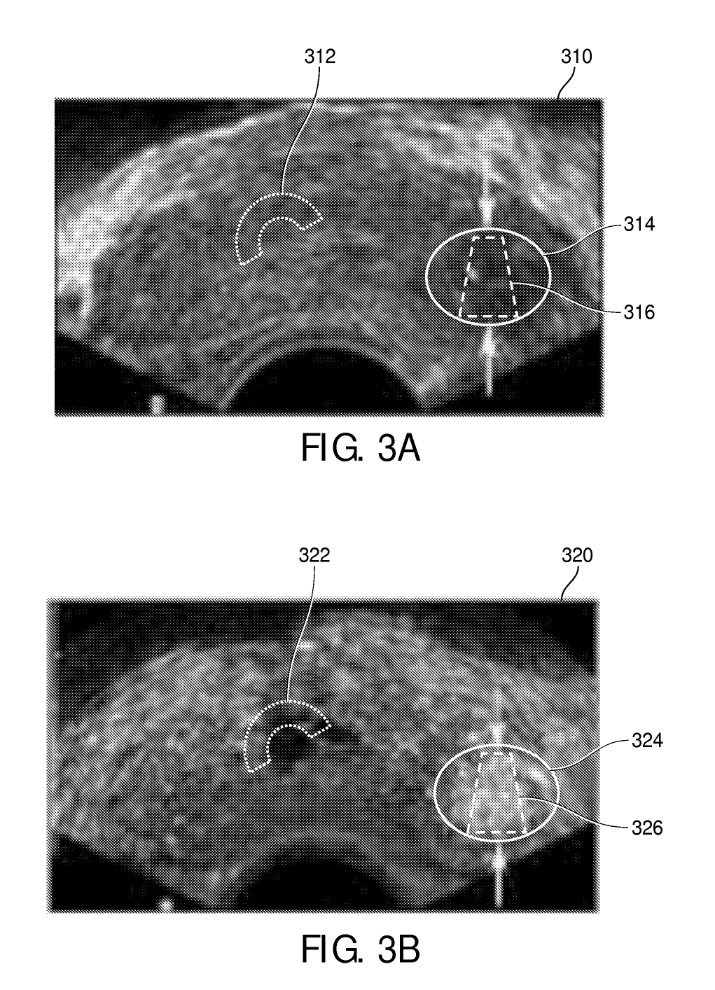

FIGS. 3A-B show exemplary acoustic images.

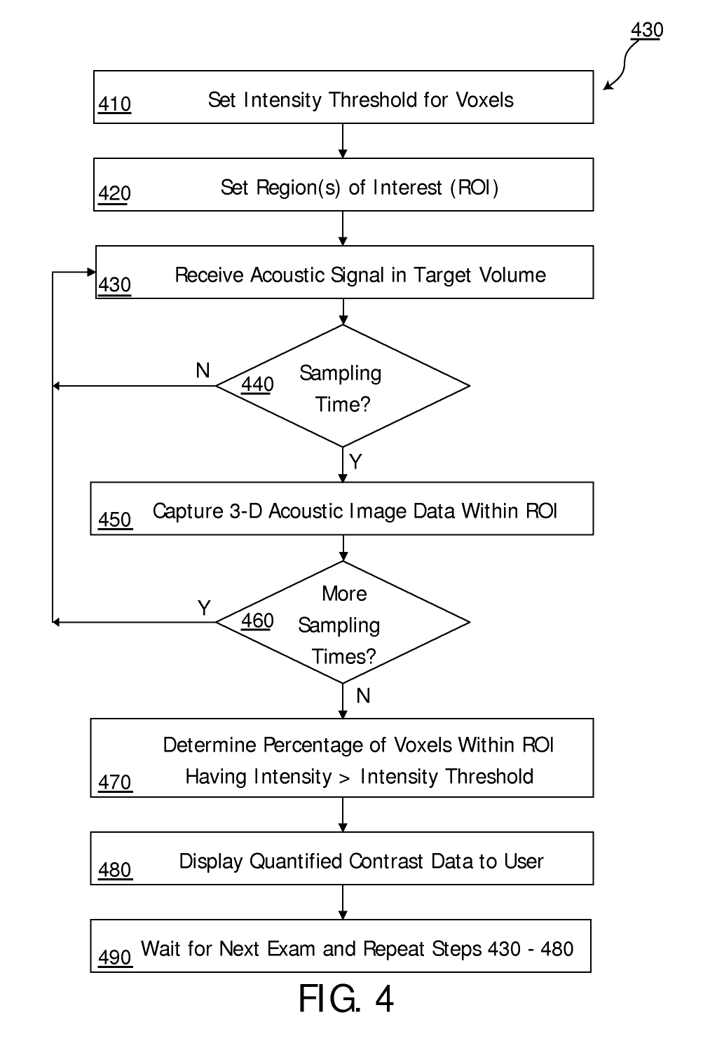

FIG. 4 illustrates a flowchart of one embodiment of a method of contrast-enhanced acoustic imaging with contrast quantification.

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention.

FIG. 1 is a high level functional block diagram of an acoustic imaging system 100. As will be appreciated by those skilled in the art, the various “parts” shown in FIG. 1 may be physically implemented using a software-controlled microprocessor, hard-wired logic circuits, or a combination thereof. Also, while the parts are functionally segregated in FIG. 1 for explanation purposes, they may be combined in various ways in any physical implementation.

Acoustic imaging system 100 includes an acoustic (e.g., ultrasound) transducer 110, an acoustic (e.g., ultrasound) signal processor 120, a display device 130, a processor 140, memory 150, and a control device 160.

In acoustic imaging system 100, acoustic signal processor 120, processor 140, and memory 150 are provided in a common housing 105. However, display device 130 may be provided in the same housing 105 as acoustic signal processor 120, processor 140, and memory 150. Furthermore, in some embodiments, housing 105 may include all of part of control device 160. Other configurations are possible.

Acoustic transducer 110 is adapted, at a minimum, to receive an acoustic signal. In one embodiment, acoustic transducer 110 is adapted to transmit an acoustic signal and to receive an acoustic “echo” produced by the transmitted acoustic signal. In another embodiment, acoustic transducer 110 receives an acoustic signal that has been transmitted or scanned by a separate device. Beneficially acoustic transducer 110 receives an acoustic signal that interrogates a three-dimensional target volume in a subject. In one embodiment, acoustic transducer 110 may include a two-dimensional acoustic transducer array that interrogates a three-dimensional volume. In another embodiment, acoustic transducer 110 may include a one-dimensional acoustic transducer array that interrogates a scan plane at any one instant, and may be mechanically “wobbled” or electronically steered in a direction perpendicular to the scan plane to interrogate a three-dimensional target volume.

In one embodiment, acoustic imaging system 100 may be provided without an integral acoustic transducer 110, and instead may be adapted to operate with one or more varieties of acoustic transducers which may be provided separately.

Acoustic (e.g., ultrasound) signal processor 120 processes a received acoustic signal to generate three-dimensional acoustic image data pertaining to a volume from which the acoustic signal is received.

Display device 130 can be any convenient type of display device (e.g., an LCD screen). In one embodiment, display device 130 may comprise a touchcreen.

Processor 140 is configured to execute one or more software algorithms in conjunction with memory 150 to provide functionality for acoustic imaging apparatus 100. In one embodiment, processor executes a software algorithm to provide a graphical user interface to a user via display device 130. Beneficially, processor 140 includes its own memory (e.g., nonvolatile memory) for storing executable software code that allows it to perform various functions of acoustic imaging apparatus 100. Alternatively, the executable code may be stored in designated memory locations within memory 150. Memory 150 also may store data in response to the processor 140.

Control device 160 provides a means for a user to interact with and control acoustic imaging apparatus 100.

Although acoustic imaging system 100 is illustrated in FIG. 1 as including processor 140 and a separate acoustic signal processor 120, in general processor 140 and acoustic signal processor 120 may comprise any combination of hardware, firmware, and software. In particular, in one embodiment the operations of processor 140 and acoustic signal processor 120 may be performed by a single central processing unit (CPU). Many variations are possible consistent with the acoustic imaging system disclosed herein.

In one embodiment, processor 140 is configured to execute a software algorithm that provides, in conjunction with display device 130, a graphical user interface to a user of acoustic imaging apparatus 100.

Input/output port(s) 180 facilitate communications between processor 140 and control device 160 and/or other devices. Input/output port(s) 180 may include one or more USB ports, Firewire ports, Bluetooth ports, wireless Ethernet ports, custom designed interface ports, etc. In one embodiment, processor 140 receives one or more control signals from control device 160 via an input/output port 180.

FIG. 2 illustrates one embodiment 200 of the acoustic imaging system 100 of FIG. 1.

Acoustic imaging apparatus 100 will now be explained in terms of an operation thereof.

Beneficially, acoustic imaging system 100 is adapted to perform contrast-enhanced acoustic (e.g., ultrasound) imaging. Typically, in contrast-enhanced acoustic imaging, an acoustic contrast-enhancement agent or material (e.g., gas-filled microbubbles) is intravenously injected into a subject's circulatory system.

A variety of microbubble contrast agents exist. Microbubbles differ in their shell composition and in their encapsulated gas core. Selection of a shell material determines how easily the microbubble is taken up by the immune system. A more hydrophilic material tends to be taken up more easily, which reduces the microbubble residence time in the circulation. This reduces the time available for contrast imaging. The shell material also affects microbubble mechanical elasticity. The more elastic the material, the more acoustic energy it can withstand before bursting. Currently, microbubble shells are typically composed of albumin, galactose, lipid, or polymers. The gas core is the most important part of the ultrasound contrast microbubble because it determines the echogenicity of the microbubble. When gas bubbles are caught in an ultrasonic frequency field, they compress, oscillate, and reflect a characteristic echo—this generates the strong and unique sonogram in contrast-enhanced ultrasound. Gas cores can be composed of air, or heavy gases like perfluorocarbon, or nitrogen. Heavy gases are less water-soluble so they are less likely to leak out from the microbubble to impair echogenicity. Therefore, microbubbles with heavy gas cores are likely to last longer in circulation.

OPTISON is one a Food and Drug Administration (FDA)-approved microbubble. OPTISON has an albumin shell and octafluoropropane gas core. LEVOVIST is one a Food and Drug Administration (FDA)-approved microbubble. LEVOVIST has a lipid/galactose shell and an air core.

Regardless of the shell or gas core composition, microbubble size is typically fairly uniform. Microbubbles are typically within in a range of 1-4 μm in diameter. That makes them smaller than red blood cells, which allows them to flow easily through the circulation as well as the microcirculation.

In a contrast-enhanced acoustic examination, these microbubbles are injected intravenously into the systemic circulation of a subject or patient who is being examined. The microbubbles remain in the systemic circulation for a certain period of time. During that time, acoustic (e.g., ultrasound) waves are directed to a target volume within the subject's body. When the microbubbles in the blood flow within the target volume that is being imaged by the acoustic waves, the microbubbles' compressible gas cores oscillate in response to the sonic energy field. The microbubbles reflect a unique echo that stands in stark contrast to the surrounding tissue due to the orders of magnitude mismatch between microbubble and tissue echogenicity. Acoustic imaging system 100 converts the strong echogenicity into contrast-enhanced three-dimensional acoustic image data for the target volume. In this way, the bloodstream's echo is enhanced, thus allowing a physician or clinician to distinguish blood from surrounding tissues. The blood perfusion into the tissue in a region of interest can be observed via the contrast-enhanced acoustic image data during various phases of the blood-flow cycle: pre-contrast, wash-in (arterial phase), and wash-out (venal phase).

FIG. 3A is an acoustic image 310 of a prostate produced from normal acoustic image data without the use of a contrast-enhancement agent. As can be seen in FIG. 3A, acoustic image 310 shows a dark “hypoechoic” area indicated between the white arrows, indicating a tumor in the left base of the prostate.

FIG. 3B is an acoustic image 320 of the same prostate shown in FIG. 3A produced with a contrast-enhancement agent (e.g., microbubbles) during a contrast exam. The bright area in acoustic image 320 indicates the area of the enhanced echo from the microbubbles due to blood perfusion into the tumor during the examination.

A series of several contrast-enhanced acoustic imaging examinations may be performed on a patient at different times (e.g., days or weeks apart from each other) during the course of a treatment protocol to assess the changes (if any) in the tumor vascularity over time during the treatment period.

In an exemplary embodiment, each contrast-enhanced acoustic imaging examination performed with acoustic imaging system 100 may proceed generally as follows.

Prior to administering the contrast agent, acoustic imaging system 100 may capture 3D acoustic image data for a target volume (e.g., a prostate) in the patient's body. Beneficially, this 3D acoustic image data may be processed to produce one or more 2D acoustic images (e.g., acoustic image 310) that may be displayed via display device 130.

Next, the contrast-enhancement agent (e.g., microbubbles) is introduced into the subject's circulatory system and a contrast examination is performed. During the contrast examination, acoustic imaging system 100 automatically acquires 3D contrast-enhanced acoustic image data for the target volume at one or more selected sampling times. Beneficially, the 3D contrast-enhanced acoustic image data comprises a plurality of voxels spanning the target volume, where each voxel has an associated intensity value corresponding to the intensity of the acoustic signal received from that voxel. The sampling times may be selected in accordance with a particular protocol. In one embodiment, the sampling times may be selected to be at specific time delays or offsets (e.g., 0, 30, 60, and 180 seconds) with respect to the time when the contrast enhancement medium is introduced into the subject's circulatory system. In one embodiment, a sampling time is selected to correspond to a time when the perfusion of blood with the microbubbles into a region of interest is at or near its maximum. Beneficially, during the contrast exam a long loop of 2D contrast-enhanced acoustic images (e.g., acoustic image 320) are captured and displayed by acoustic imaging system 100 during the pre-contrast, wash-in and wash-out parts of the blood flow cycle.

One or more regions of interest within the target volume are identified for further analysis of the 3D contrast-enhanced acoustic image data by acoustic imaging system 100, which will be described in more detail below. Beneficially, the region(s) of interest may correspond to areas where a tumor is known or suspected to exist. Beneficially, the region(s) of interest are selected in connection with a first contrast-enhanced acoustic imaging examination of a series of such contrast-enhanced acoustic imaging examinations that are performed during a course of treatment, and the same region(s) of interest is/are tracked for each subsequent contrast-enhanced acoustic imaging examination.

In one arrangement, a user may identify one or more regions of interest 312, 314 and 316 by annotating “pre-contrast” acoustic image 310 via control device 160. In another arrangement, a user may identify one or more regions of interest 322, 324 and 326 by annotating contrast-enhanced acoustic image 320 via control device 160. In yet another arrangement, processor 140 of acoustic imaging system 100 may execute a feature recognition algorithm on acoustic image 310 and/or acoustic image 320 to identify and select one or more regions of interest for further analysis. For example, with respect to acoustic image 320, a feature recognition may identify the bright region(s) 324 and/or 326 as regions(s) of interest.

In one embodiment, the region(s) of interest are selected from the 2D loop data and/or the 3D acoustic image data (or from acoustic images generated therefrom) during, or after, a contrast exam is performed. However, in some embodiments the region(s) of interest in the target volume may be selected prior to capturing the 3D contrast-enhanced acoustic image data for the target volume. In that case, it may be possible to capture only the 3D contrast-enhanced acoustic image data for the region(s) of interest, rather than the entire target volume. This would reduce the amount of image data that would need to be captured, stored and processed, simplifying the requirements placed on the processor(s) 120 and/or 140, and reducing the amount of required memory 150.

Accordingly, acoustic imaging system 100 captures three-dimensional acoustic image data for the region(s) of interest at the selected sampling times during the contrast exam.

Then, acoustic imaging system 100 processes the three-dimensional acoustic image data in the region of interest for one or more of the selected sampling times to quantify the amount of contrast present in the image data. Beneficially, the contrast will generally correspond to the amount of blood perfusion in the region of interest at the selected sampling time. That is, during the contrast exam microbubbles are carried along with the blood supply and each microbubble produces an acoustic echo that will be stronger than the surrounding tissue. A strong acoustic echo manifests itself as a strong intensity value for the corresponding voxel(s) in the three-dimensional acoustic image data. As more blood perfuses into a region of interest, then more microbubbles are present, and therefore more voxels in the region of interest have strong intensity values. By quantifying the contrast in the three-dimensional acoustic image data in the region of interest, one can quantitatively assess the blood perfusion in the region of interest. In one embodiment, the quantification of the contrast in the three-dimensional acoustic image data in the region of interest is expressed as a contrast index (CI).

In one embodiment, the selected sampling times are selected to be at specific time delays or offsets (e.g., 0, 30, 60, and 180 seconds) with respect to the time when the contrast enhancement medium is introduced into the subject's circulatory system. In one embodiment, a sampling time is selected to correspond to a time when the perfusion of blood including the microbubbles into a region of interest is at or near its maximum. Beneficially, sampling times are selected corresponding to the pre-contrast, wash-in and wash-out parts of the blood flow cycle. Acoustic imaging system 100 processes the three-dimensional acoustic image data for each of these sampling times to quantify the contrast in the region(s) of interest at each sampling time(s).

In one embodiment, acoustic imaging system 100 quantifies the contrast of the acoustic image data in each region of interest by calculating a value for a contrast index (CI) for the region. In that case, in one embodiment acoustic imaging system 100 calculates the CI value by setting an intensity threshold, and determining a percentage of the voxels of the three-dimensional acoustic image data for the region of interest which have an intensity value greater than the intensity threshold. Beneficially, the intensity threshold is selected to be less than the intensity produced by acoustic echoes from the microbubbles, but greater than the intensity produced by acoustic echoes from surrounding tissue in the region(s) of interest.

Once the CI value is calculated for the region(s) of interest at the selected sampling time(s), this information can be displayed to a user in a variety of manners as selected by a user (e.g., via control device 160 and a graphical user interface displayed on display device 130). In one embodiment, acoustic imaging system 100 includes a user-selectable option to display on display device 130 the CI value for each region of interest as a function of time during the contrast exam—for example, as a function of the blood flow cycle. In one embodiment, acoustic imaging system 100 includes a user-selectable option for display device 130 to overlay and the CI value(s) with one or more acoustic images of the corresponding region of interest. In one embodiment, a color-coded key is provided for different ranges of CI values, and acoustic imaging system 100 includes a user-selectable option for display device 130 to display a color-coded acoustic image of one or more regions of interest where the color of each region corresponds to the CI value for that region.

Acoustic imaging system 100 may store and save all or any combination of the three-dimensional acoustic image data for the region(s) of interest for each sampling time, and the associated CI value(s).

Beneficially, acoustic imaging system 100 may repeat the procedure described above for each of a plurality of contrast exams performed as various times (e.g., days or weeks apart from each other). A series of contrast exams may be performed over a period of time to gather information which may assist a physician in determining whether a tumor is benign or malignant. Also, a series of contrast exams may be performed during the course of a treatment protocol to assess the reaction of the tumor to the treatment. In that case, acoustic imaging system 100 captures and processes three-dimensional acoustic image data for the region(s) of interest for a plurality of times during the course of the treatment. Beneficially, this three-dimensional acoustic image data can be used to assess the changes (if any) in a tumor's vascularity over time during the treatment period. For example, where the vascularity remains stable or decreases over a period of time, it may be determined that the tumor is benign.

In one embodiment, acoustic imaging system 100 includes one or more user-selectable options for display device 130 to generate and display one or more graphs which plot the CI value(s) for one or more regions of interest at specific sampling times as a function of the different times when the contrast exam is performed. In response to a user input (e.g., via control device 160 and a graphical user interface displayed on display device 130), acoustic imaging system 100 may generate and display a variety of different graphs. For example, display device 130 may display a graph that plots the CI value for a region of interest at a selected sampling time after the contrast enhancement media (e.g., microbubbles) is introduced into the subject's circulatory system when the contrast is the highest (indicating the time of greatest perfusion of the blood with the microbubbles), as a function of the different times when the contrast exam is performed.

In one embodiment, acoustic imaging system 100 assesses the changes in the CI value over a series of contrast exams for a region of interest that includes a tumor, and makes a preliminary determination that the tumor is benign or malignant based on whether the CI value remains stable or decreases (benign), or increases (malignant). In one embodiment, display device 130 may display an acoustic image illustrating one or more region(s) of interest, and may color-code each region of interest with a color that indicates whether the tumor is preliminarily determined to be benign (e.g., green) or malignant (e.g., red).

FIG. 4 illustrates a flowchart of one concrete embodiment of a method 400 of contrast-enhanced acoustic imaging with contrast quantification. The algorithm illustrated in FIG. 4 may be executed by processor 140 of It should be understood that FIG. 4 only illustrates one embodiment, and many variations are possible, including arrangement of the order of various steps, as appropriate.

In a step 410, acoustic imaging system 100 sets an intensity threshold for voxels in three-dimensional acoustic image data to be captured and processed by acoustic imaging system 100 during a contrast exam. Beneficially, the intensity threshold is selected to be less than the intensity produced by acoustic echoes from a contrast-enhancement agent (e.g., microbubbles), but greater than the intensity produced by acoustic echoes from surrounding tissue within a subject or patient who is being examined.

In a step 420, one or more regions of interest are defined or selected for the subject or patient who is being examined. The region(s) of interest are located within a target volume that is acoustically interrogated (e.g., by acoustic transducer 110) and from which an acoustic signal is received by acoustic imaging system 100.

In a step 430, acoustic imaging system 100 receives an acoustic signal from the target volume of the subject or patient who is being examined. At some point in time, the contrast-enhancement agent (e.g., microbubbles) is introduced into the subject's circulatory system, e.g., via intravenous injection. Beneficially, the user notifies the acoustic imaging system 100 of the time when the microbubbles are introduced into the subject's circulatory system, for example via control device 160 (e.g., by clicking a mouse button, pushing a key on a keyboard, touching a button on a touchscreen, etc.).

In a step 440, acoustic imaging system 100 determines whether the current time corresponds to a selected sampling time. If not, then the process returns to step 430 and acoustic imaging system 100 continues to receive the acoustic signal. However, when the current time corresponds to a selected sampling time, then the process proceeds to step 450.

In a step 450, acoustic imaging system 100 captures three-dimensional acoustic image data at least within the selected region(s) of interest. In one embodiment, acoustic imaging system 100 captures three-dimensional acoustic image data for the entire target volume that is being acoustically interrogated.

In a step 460, acoustic imaging system 100 determines whether or not there are more sampling times for capturing three-dimensional acoustic image data. If so, then the process returns to step 430 and acoustic imaging system 100 continues to receive the acoustic signal. If not, then the process proceeds to step 470.

In a step 470, acoustic imaging system 100 processes the captured three-dimensional acoustic image data to quantify the contrast within one or more region(s) of interest. In one embodiment, acoustic imaging system 100 calculates a contrast index (CI) for each region of interest as a percentage of the voxels within the three-dimensional acoustic image data for the region of interest that have an intensity greater than the intensity threshold.

In a step 480, acoustic imaging system 100 includes one or more user-selectable options for display device 130 to generate and display one or more graphs, as explained in detail above.

Then, in step 490, acoustic imaging system 100 waits for the next contrast exam (e.g., days or weeks later) and repeats the process, beginning at step 430.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A method of acoustic imaging, comprising:
(i) receiving an acoustic signal that is scanned to interrogate a target volume within a subject;
(ii) processing the received acoustic signal to produce three-dimensional acoustic image data for a region of interest within the target volume; and
(iii) quantifying a contrast of the three-dimensional acoustic image data in the region of interest at a sampling time that is offset by a selected time period with respect to a time when a contrast enhancement medium is introduced into the subject's circulatory system, wherein quantifying the contrast of the three-dimensional acoustic image data in the region of interest comprises:
setting an intensity threshold; and
determining a percentage of voxels of the three-dimensional acoustic image data for the region of interest which have an intensity value greater than the intensity threshold.

2. (canceled)

3. The method of claim 1, further comprising:
repeating steps (i) through (iii) for a plurality of different times when the contrast enhancement medium is introduced into the subject's circulatory system; and
displaying on a display device an indication of the quantified contrast as a function of the different times.

4. The method of claim 3, wherein the plurality of different times when the contrast enhancement medium is introduced into the subject's circulatory system include at least two times separated from each other by a period of at least one day.

5. The method of claim 3, wherein the plurality of different times when the contrast enhancement medium is introduced into the subject's circulatory system span a period of more than one week.

6. The method of claim 3, wherein said displaying comprises displaying a graph plotting the quantified contrast for each of the different times when the contrast enhancement medium is introduced into the subject's circulatory system.

7. The method of claim 1, further comprising receiving at least one input from a user to select the region of interest.

8. The method of claim 1, wherein the region of interest is selected using a feature recognition algorithm.

9. The method of claim 1, further comprising performing steps (i) through (iii) for a plurality of different regions of interest within the target volume.

10. The method of claim 1, further comprising repeating steps (i) through (iii) for a plurality of different sampling times, each of the sampling times being offset by a different selected time period with respect to the time when the contrast enhancement medium is introduced into the subject's circulatory system.

11. The method of claim 10, wherein the plurality of different sampling times are selected to correspond to different phases of the subject's cardiac cycle.

12. The method of claim 10, further comprising repeating steps (i) through (iii) for a plurality of different times when the contrast enhancement medium is introduced into the subject's circulatory system.

13. An acoustic imaging system, comprising:
a processor adapted to process an acoustic signal that is scanned to interrogate a target volume within a subject, and which acoustic signal is received by an acoustic transducer;
a display device for displaying images in response to the processed acoustic signal;
a control device that is adapted to allow a user to control at least one operating parameter of the acoustic imaging apparatus,
wherein the processor is configured to execute an algorithm comprising:
(i) processing the received acoustic signal to produce three-dimensional acoustic image data for a region of interest within the target volume; and
(ii) quantifying a contrast of the three-dimensional acoustic image data in the region of interest at a sampling time that is offset by a selected time period with respect to a time when a contrast enhancement medium is introduced into the subject's circulatory system, wherein quantifying the contrast of the three-dimensional acoustic image data in the region of interest comprises:
setting an intensity threshold; and
determining a percentage of voxels of the three-dimensional acoustic image data for the region of interest which have an intensity value greater than the intensity threshold.

14. (canceled)

15. The system of claim 13 wherein the sampling time is selected as a time when a maximum percentage of the voxels of the three-dimensional acoustic image data for the region of interest have an intensity value greater than the intensity threshold.

16. The system of claim 13, wherein the algorithm further comprises:
repeating steps (i) and (ii) for a plurality of different times when the contrast enhancement medium is introduced into the subject's circulatory system; and
displaying on a display device an indication of the quantified contrast as a function of the different times.

17. The system of claim 13, wherein the processor is adapted to receive at least one input from the control device to select the region of interest.

18. The system of claim 13, wherein the processor executes a feature recognition algorithm to select the region of interest.

19. The system of claim 13, wherein the algorithm further comprises performing steps (i) and (ii) for a plurality of different regions of interest within the target volume.

20. The system of claim 13, wherein the algorithm further comprises repeating steps (i) and (ii) for a plurality of different sampling times, each of the sampling times being offset by a different selected time period with respect to the time when the contrast enhancement medium is introduced into the subject's circulatory system.

21. The system of claim 16, wherein the algorithm further comprises displaying a graph plotting the quantified contrast for each of the different times when the contrast enhancement medium is introduced into the subject's circulatory system.

22. The system of claim 20, wherein the plurality of different sampling times are selected to correspond to different phases of the subject's cardiac cycle.
